(19) United States
(12) Patent Application Publication
(10) Pub. No.: US 2014/0117714 A1
(43) Pub. Date: May 1, 2014

(54) IMPACT-ABSORBING AUXILIARY MATERIAL FOR VEHICLE

(71) Applicants: DAEHAN SOLUTION CO., LTD, Incheon (KR); IPSUNG CO., LTD., Hwaseong-si (KR)

(72) Inventor: Choong Ho KWON, Seoul (KR)

(73) Assignees: IPSUNG CO., LTD., Hwaseong-si (KR); DAEHAN SOLUTION CO., LTD, Incheon (KR)

(21) Appl. No.: 13/747,668

(22) Filed: Jan. 23, 2013

(30) Foreign Application Priority Data
Oct. 31, 2012 (KR) 10-2012-0121851

(51) Int. Cl. B60R 21/04

(52) U.S. Cl. CPC B60R 21/04
USPC 296/187.05

(57) ABSTRACT

Provided is an impact-absorbing auxiliary material for a vehicle, which is fabricated using pulp so that a mold may be easily fabricated without regard to a shape of the auxiliary material for absorbing the impact, and moreover, which is environmentally friendly and does not generate a waste treatment problem when being discarded. Also provided is an impact-absorbing auxiliary material of a vehicle, which is capable of obtaining a sufficient impact-absorbing performance required in the impact-absorbing auxiliary material through continuous deformation of ridges and ribs by connecting ribs between hollow ridge portions and forming integrally. The auxiliary material includes a base fabricated using pulp, wherein hollow ridges integrally protrude from the base in a plurality of rows at predetermined intervals, and the ridges adjacent to each other are connected to each other through ribs.

### CROSS-REFERENCE TO RELATED APPLICATION

This application claims priority to and the benefit of Korean Patent Application No. 10-2012-0121851, filed on Oct. 31, 2012, the disclosure of which is incorporated herein by reference in its entirety.

### BACKGROUND

1. Field of he Invention The present invention relates to an impact-absorbing auxiliary material for a vehicle, and more particularly, to an impact-absorbing auxiliary material that is fabricated using recyclable pulp, so as to fabricate an environmentally friendly impact-absorbing auxiliary material for a vehicle through recycling, while achieving superior physical properties to those of a resin material in the related art and reducing initial investment costs.

2. Discussion of Related Art

In general, vehicles exported to the United States of America have to satisfy a regulation (FMVSS 201U) of installing indoor impact-absorbing structures for protecting passengers such as a driver when the vehicles are impacted from the outside. According to the above regulation, when designing built-in (interior) components of a vehicle, a method of designing an impact-absorbing structure for satisfying FMH impact performance is necessary.

FIG. 1 shows an impact-absorbing auxiliary material 10 that is mounted between a roof panel boundary and a head lining of a vehicle to protect heads of passengers including a driver, according to the above regulation. In FIG. 1, the impact-absorbing auxiliary material 10 is formed by arranging a plurality of ribs 11 that are formed as band segments of plate shape at predetermined intervals, and forming sub-ribs 12 between the plurality of ribs 11 integrally at predetermined intervals.

In particular, the impact-absorbing auxiliary material 10 is fabricated using a synthetic resin so as to be deformed and crushed when body parts (head) of a passenger collide with the impact-absorbing auxiliary material 10 due to impacts applied to the vehicle, thereby obtaining an impact-absorbing effect. However, the above impact-absorbing auxiliary material in the related art has the following problems.

(1) Because the impact-absorbing auxiliary material is formed of a resin material, residues that are classified as industrial waste are generated during fabrication processes of the impact-absorbing auxiliary material. Also, produced goods are also classified as industrial waste when being discarded, and thus, discard costs increase and environmental pollution may occur.

(2) The impact-absorbing auxiliary material in the related art absorbs the impact using a structural characteristic thereof, and to do this, the impact-absorbing auxiliary material has to be formed as an integral type. Thus, the impact-absorbing auxiliary material is manufactured by a mold. However, the impact-absorbing auxiliary material has a complicated structure, and thus it is difficult to manufacture the mold, thereby increasing fabrication costs. In addition, there is a limitation in the structure of the impact-absorbing auxiliary material to be formed, and there is a limitation in absorbing the impact effectively.

### SUMMARY OF THE INVENTION

The present invention is directed to an impact-absorbing auxiliary material for a vehicle, which is fabricated using pulp so that a mold may be easily fabricated without regard to a shape of the impact-absorbing auxiliary material, and moreover, which is environmentally friendly and does not generate a waste treatment problem when being discarded.

The present invention is also directed to an impact-absorbing auxiliary material of a vehicle, which is capable of obtaining a sufficient impact-absorbing performance required in the impact-absorbing auxiliary material through successive deformation of ridges and ribs by connecting ribs between hollow ridge portions and forming integrally.

According to an aspect of the present invention, there is provided an impact-absorbing auxiliary material including a base fabricated using pulp, wherein hollow ridges integrally protrude from the base in a plurality of rows at predetermined intervals, and the ridges adjacent to each other are connected to each other through ribs.

Each of the ridges may be configured to form a triangle or an equilateral triangle with other adjacent ridges. Each of the ridges may be formed as a hexagonal cone shape, and may have a maximum inner diameter of about 15 to 20 mm.

The ridges and the ribs may be configured to protrude to a height of about 5 to 15 mm. Each of the ribs may have a length of about 15 to 30 mm.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a perspective view of a configuration of an impact-absorbing auxiliary material in the related art;

FIG. 2 is a perspective view of an impact-absorbing auxiliary material according to an embodiment of the present invention;

FIG. 3A is a cross-sectional view of the configuration of the impact-absorbing auxiliary material according to the embodiment of the present invention taken along line A-A of FIG. 2;

FIG. 3B is a plan view of the configuration of the impact-absorbing auxiliary material according to the embodiment of the present invention; FIG. 4 shows photographs of the impact-absorbing auxiliary material before and after an impact test illustrating a result of the impact test according to the embodiment of the present invention; and

FIG. 5 is a graph showing a result of an impact performance test of the impact-absorbing auxiliary material, according to the embodiment of the present invention.

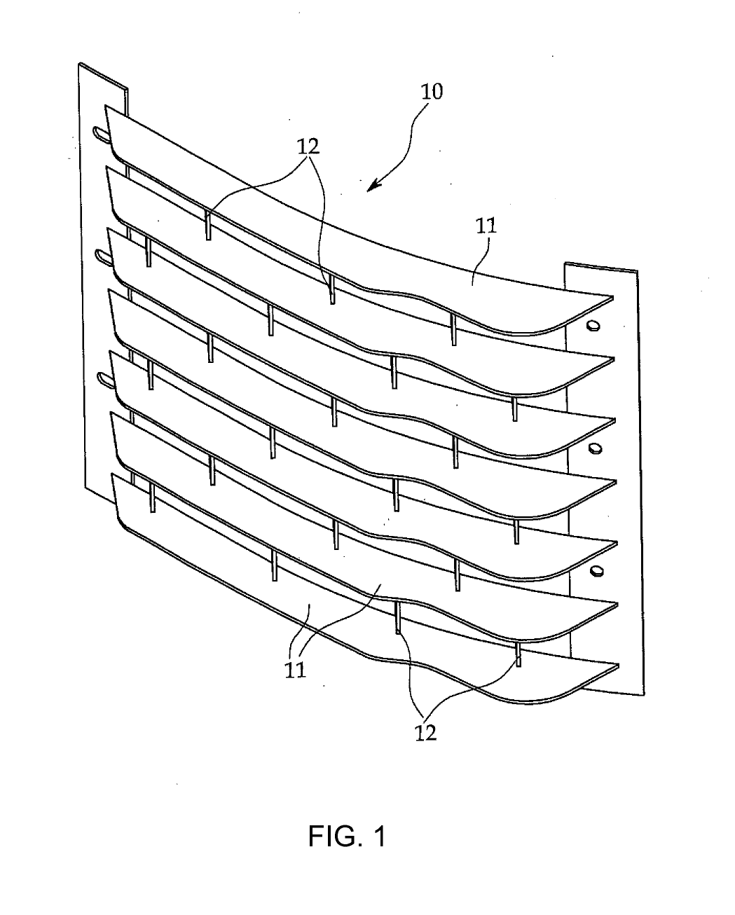

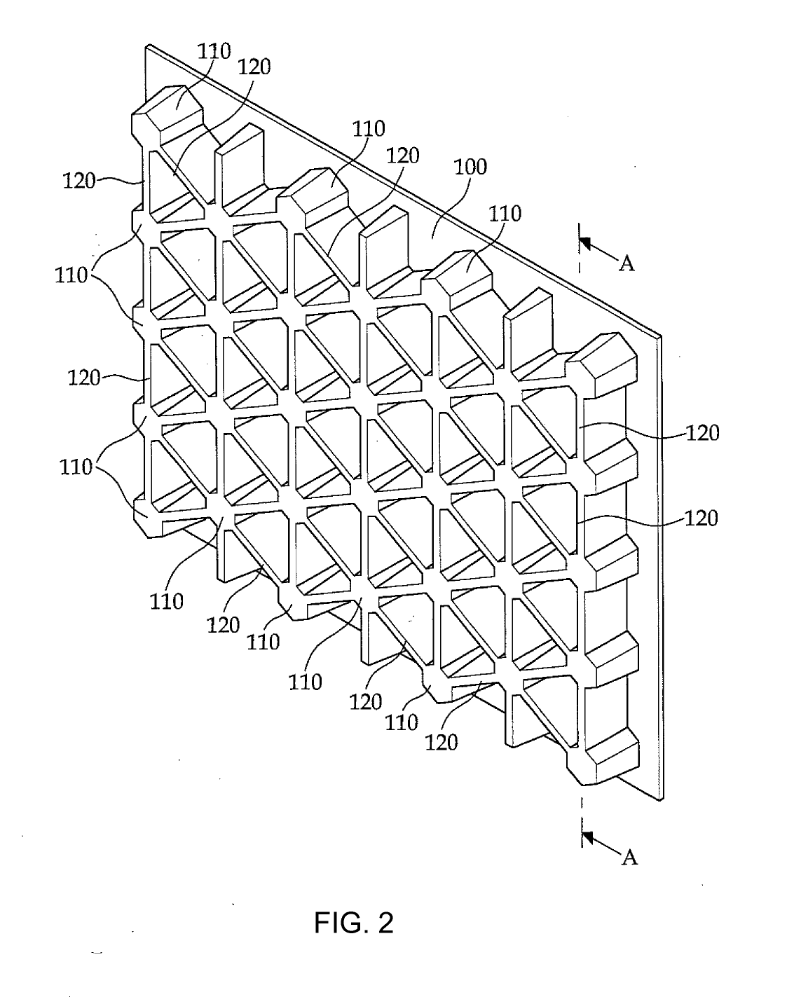

### DETAILED DESCRIPTION OF EXEMPLARY EMBODIMENTS

Exemplary embodiments of the present invention will be described in detail below with reference to the accompanying drawings. Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Although a few embodiments of the present invention will be shown and described, it would be appreciated by those skilled in the art that changes may be made in these exemplary embodiments without departing from the principles and spirit of the invention, the scope of which is defined in the claims and their equivalents.

(Configuration)

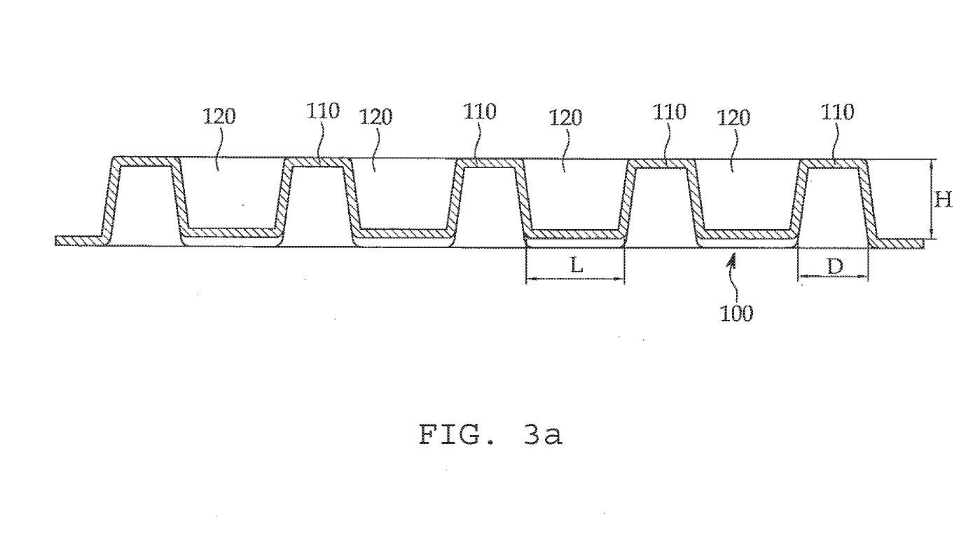

As shown in FIGS. 2 through 4, an impact-absorbing auxiliary material according to an embodiment of the present invention includes a base 100 of a plate shape formed of pulp, a plurality of hollow ridges 110 formed integrally on the base 100 in a plurality of rows, and ribs 120 connecting the plurality of ridges 110 to each other. Thus, a sufficient impact-absorbing function can be obtained through continuous deformation of the ridges 110 and the ribs 120, and accordingly, the ridges 110 and the ribs 120 are formed of pulp, like the base 100, so as to be recyclable.

Hereinafter, the above configuration will be described in detail.

The impact-absorbing auxiliary material according to the embodiment of the present invention is fabricated using pulp to be recyclable. The impact-absorbing auxiliary material includes the base 100 of the plate shape having a predetermined size.

In particular, the ridges 110 integrally protrude from the base 100 in a plurality of rows. Here, each of the ridges 110 may be formed to be hollow to obtain an impact-absorbing effect when it is deformed due to the impact.

Also, each of the ridges 110 may be integrally formed with the base 100 so as to configure to form a triangle shape, in particular, an equilateral triangle shape, with other adjacent ridges 110. Thus, hexagonal shapes are configured with the ribs 120 formed between the ridges 110, as shown in FIG. 4, in order to increase structural rigidity.

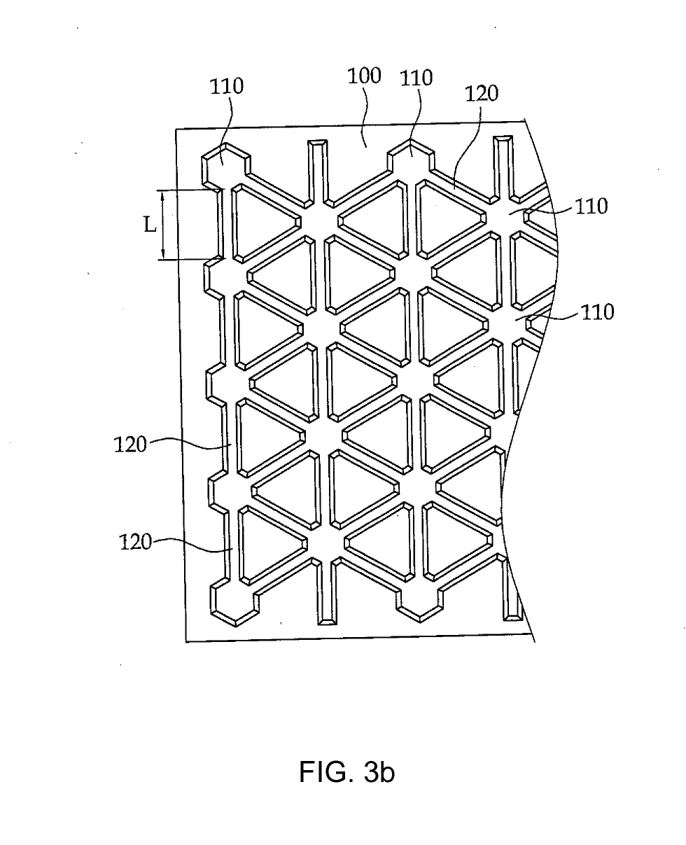

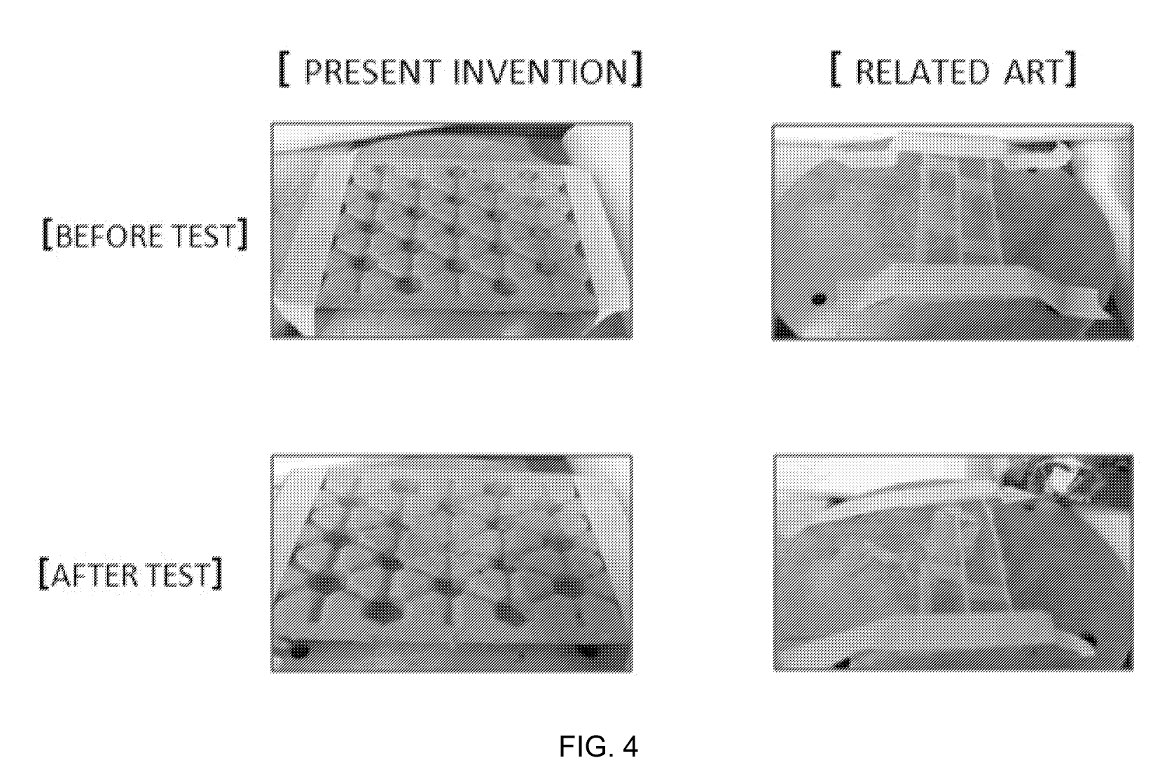

In addition, each of the ridges 110 may be formed as a circular cylinder shape for ensuring rigidity; however, each of the ridges 110 may preferably be formed as a hexagonal cone shape to be deformed easier than the circular cylinder shape. As shown in FIGS. 3A and 3B, the above ridge 110 may be formed to have a protruding height H from the base 100 of about 5 to 15 mm and a maximum inner diameter D of about 15 to 20 mm in consideration of an interval between a roof panel and a head lining of a vehicle.

Meanwhile, the ribs 120 are formed between the ridges 110. Each of the ribs 120 is formed to have a height that is the same as that of the ridge 110 and a length L thereof of about 15 to 30 mm. Such ribs 120 are formed integrally on the base 100 with the ridges 110 so as to support the ridges 110 between the ridges 110.

(Impact Performance Test)

Impact performance tests of the impact-absorbing auxiliary material formed of the pulp according to the embodiment of the present invention and an impact-absorbing auxiliary material in the related art formed of plastic were performed, and results are shown as follows.

First, test conditions of the auxiliary materials for absorbing impact are as shown in the following Table 1.

TABLE 1

| | | | | Present | | Present | |
|---|---|---|---|---|---|---|---|
| Classification | | Related_art | | invention 1 | | invention 2 | |
| Test | Dropping height | 0.7 | M | 0.7 | M | 0.7 | M |
| conditions | Height of | 15 | mm | 15 | mm | 15 | mm |
| | thread (auxiliary | | | | | | |
| | materials) | | | | | | |
| | Area | 63 × 144 | (mm²) | 181 × 122 | (mm²) | 181 × 122 | (mm²) |

1) Height of thread: a height of a ridge (present invention), and a height of a rib (related art)
2) Area denotes an area of a base.
3) The present invention 1 and the present invention 2 are specimens fabricated in the same way.

The impact performance test was performed using a triaxial accelerometer.

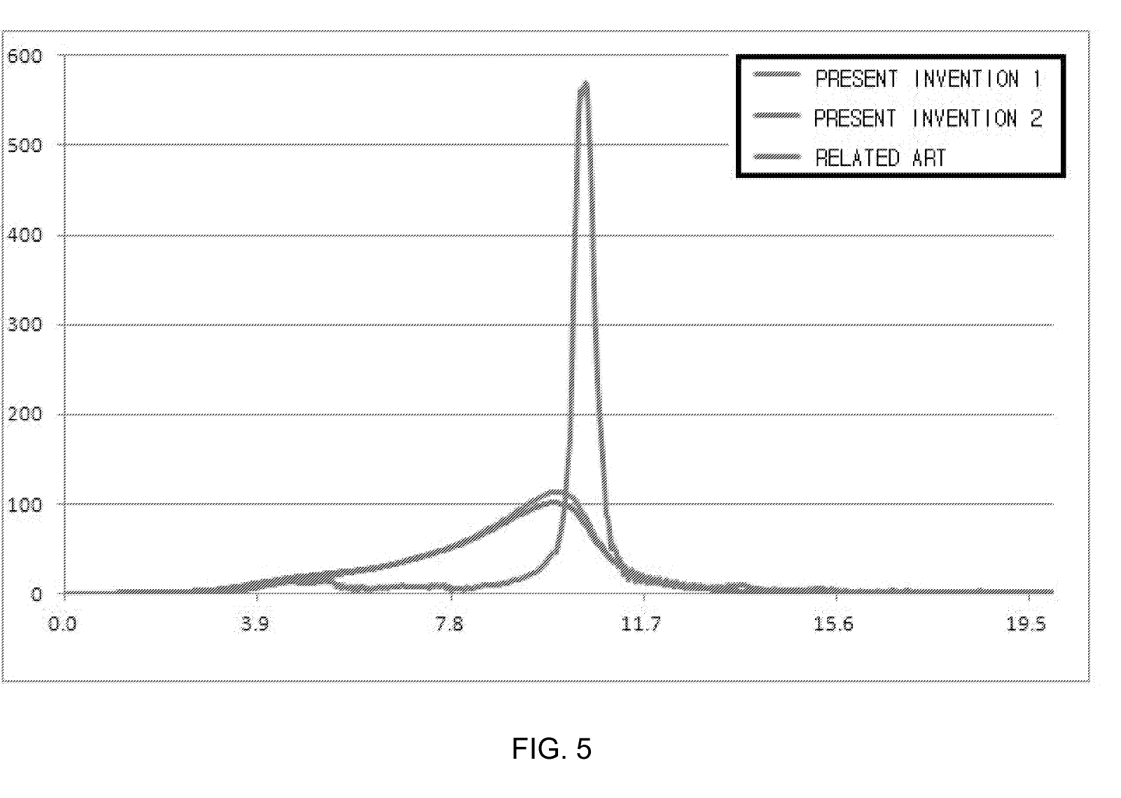

First, free-fall of a sphere on which the triaxial accelerometer was installed was performed from a height of 0.7 m, and then a variation in acceleration occurring when the sphere impacted each of the specimens was compared with others. Comparison results are shown in FIGS. 4 and 5.

In FIG. 4, some of the ridges and the ribs on portions at which the sphere impacted were crushed in the impact-absorbing auxiliary material according to the present invention; however, the impact-absorbing auxiliary material in the related art was totally crushed.

FIG. 5 is a graph showing a variation of the acceleration according to time. Referring to FIG. 5, in the impact-absorbing auxiliary material in the related art, it may be found that the acceleration instantly increases, and then rapidly decreases. In the impact-absorbing auxiliary material according to the present invention, it may be found that the acceleration value is low, and moreover, time for receiving the impact is longer than that of the related art.

That is, it may be considered that the impact-absorbing auxiliary material according to the present invention absorbs the impact for a longer period with a lower impact than those of the impact-absorbing auxiliary material in the related art. That is, it may be considered that the impact-absorbing auxiliary material according to the present invention may absorb the impact from the outside effectively.

Therefore, it may be found that the impact-absorbing auxiliary material according to the present invention has superior impact-absorbing performance to that of the impact-absorbing auxiliary material in the related art. The impact-absorbing auxiliary material according to the present invention has following effects.

(1) Since the impact-absorbing auxiliary material is fabricated using pulp, it has excellent formability. Therefore, the impact-absorbing auxiliary material having a complicated shape is easily fabricated in accordance with the shape thereof, and accordingly, a structure that is required to absorb the impact may be easily formed to effectively absorb the impact.

(2) Since pulp that is environmentally friendly is used as a raw material, there is no a waste treatment problem, and moreover, the impact-absorbing auxiliary material of the present invention does not cause environmental pollution.

(3) Since a pulp mold may be easily fabricated in a mold fabrication compared to a plastic mold in the related art, initial investment costs may be reduced.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An impact-absorbing auxiliary material for a vehicle, the auxiliary material comprising a base fabricated using pulp, wherein the base comprises hollow ridges integrally protruding from the base in a plurality of rows at predetermined intervals, and the ridges adjacent to each other are connected to each other through ribs.

2. The impact-absorbing auxiliary material of claim 1, wherein each of the ridges is configured to form a triangle or an equilateral triangle with other adjacent ridges.

3. The impact-absorbing auxiliary material of claim 2, wherein each of the ridges is formed as a hexagonal cone shape.

4. The impact-absorbing auxiliary material of claim 3, wherein each of the ridges has a maximum inner diameter of about 15 to 20 mm.

5. The impact-absorbing auxiliary material according to any one of claims 1 through 4, wherein the ridges and the ribs are configured to protrude to a height of about 5 to 15 mm.

6. The impact-absorbing auxiliary material of claim 5, wherein each of the ribs has a length of about 15 to 30 mm.
